(19) United States
(12) Patent Application Publication
(10) Pub. No.: US 2016/0284013 A1
(43) Pub. Date: Sep. 29, 2016

(54) ORDER PROCESSING SYSTEM AND ORDER PROCESSING METHOD

(71) Applicant: HITACHI, LTD., Tokyo (JP)

(72) Inventors: Yoshiki MATSUURA, Tokyo (JP); Tetsuro ABE, Tokyo (JP)

(73) Assignee: HITACHI, LTD., Tokyo (JP)

(21) Appl. No.: 15/076,802

(22) Filed: Mar. 22, 2016

(30) Foreign Application Priority Data
Mar. 23, 2015 (JP) 2015-059593

(51) Int. Cl. G06Q 30/06

(52) U.S. Cl. CPC G06Q 30/0635

(57) ABSTRACT

It is provided an order processing system comprising: a reception part for checking the consistency of an order and receive the order maintaining consistency; and a preceding order check part for determining whether there is a dependent relationship between the attributes of the product in the received order and the attributes of the products in an order currently being processed, the preceding order check part registers the dependent relationship in a case where the received order and an order currently being processed have a dependent relationship, and determines to perform processing without controlling the received order to wait even before processing of the order currently being processed is complete in a case where there is an order currently being processed, which is made by the contracting party of the received order and there is no dependent relationship between the received order and the order currently being processed.

### CLAIM OF PRIORITY

The present application claims priority from Japanese patent application JP 2015-59593 filed on Mar. 23, 2015, the content of which is hereby incorporated by reference into this application.

### BACKGROUND

The subject matter disclosed herein relates to a method and system for receiving and processing an order relating to a product provided by a service provider.

A service provider of telecommunications services selling services to be provided to a user as products, receives and processes orders from the user for updating contract information, such as product additions and setting changes. However, in a case where change orders from the user are consecutively received and processed, an inconsistency in the final contract state may occur. For example, in a case where a user changes his or her mind and cancels a contract of a mobile data communications service while an order for adding an option to the mobile data communications service is being processed, when the service provider receives the orders consecutively, depending on the sequence in which the order processing is completed, an inconsistency may occur in the contract state of the user if the cancellation procedure is completed before the processing of the order for adding an option is completed.

JP 2007-316988 A is the related art relating to this technology. In JP 2007-316988 A, an order management system is described in which a determination module is configured to determine, when a subsequent order from an operator terminal is received after a preceding order, the consistency of the subsequent order based on a current state of contract information or customer information relating to the subsequent order, and on the content of the orders that have the same contract information or the same customer information as the subsequent order and that have not yet been processed among already received orders. A registration module is configured to register, in a case where it is determined that the subsequent order is consistent, the subsequent order in a storage module regardless of whether or not processing of the preceding order is complete.

In JP 2007-316988 A, a consistency determination is performed based on the current contract state and the content of an unprocessed preceding order when a subsequent order is received. In a case where it is determined that there is consistency, the subsequent order is registered as an unprocessed order, and the orders are processed in the registered sequence (paragraph of JP 2007-316988 A). According to the method described in JP 2007-316988 A, even when there is an order that is being processed, orders can be consecutively received while maintaining consistency with the final contract state.

However, in JP 2007-316988 A, because the orders are processed in the registered sequence, in a case where the processing time of the preceding order is long, the processing start of the subsequent order is delayed, causing the contract change procedure for the subsequent order to be delayed. For example, when making a change to a mobile data communications service plan as a preceding order, it can take one week to exchange a Subscriber Identity Module (SIM) card. Even if an order for adding an option, such as a terminal guarantee service, that is completed merely by performing a procedure on the contract is received as a subsequent order during processing of a preceding order, because the subsequent order is started after completion of the processing of the preceding order, the processing of the subsequent order is delayed.

On the other hand, in a case where the processing of the subsequent order requires a result of the preceding order, for example, in a case where adding a mail option for which opening processing is executed by using card information on mobile data communication, which is a preceding order, the subsequent order cannot be processed until after completion of the preceding order has been confirmed.

### SUMMARY

Therefore, this invention has a feature in that, during consecutive contract changes by the same user, a determination is made based on a dependent relationship of an opening procedure regarding whether or not consistency of a contract state is maintained even when a preceding order and a subsequent order are processed in parallel, and when consistency of the contract state is maintained, the preceding order and the subsequent order are processed in parallel.

The representative one of inventions disclosed in this application is outlined as follows. There is provided an order processing system configured with a computer, comprising a processor and a storage device capable of storing instructions executable by the processor. The storage device is configured to store specification information representing a relationship among products to be provided by a service provider, attribute information representing attributes of the products, attribute relationship information representing a dependent relationship of the attributes among the products, contract information representing a product under contract by a user and a product for which a procedure is being performed, and currently-processing order management information for managing orders currently being processed The instructions causes the processor to execute: a reception processing part configured to check the consistency of an order received from a terminal and receive the order maintaining consistency by referring to the specification information, the attribute information, and the contract information and a preceding order check processing part configured to determine whether or not there is a dependent relationship between the attributes of the product in the received order and the attributes of the products included in the orders currently being processed by referring to the currently-processing order management information and the attribute relationship information. The preceding order check processing part is configured to: register the dependent relationship in the currently-processing order management information in a case where the received order and an order currently being processed, which are made by the same contracting party, have a dependent relationship in terms of an attribute of a subject product; and determine to perform processing without controlling the received order to wait even before processing of the order currently being processed is complete in a case where there is an order currently being processed, which is made by the same contracting party of the received order, and there is no dependent relationship between the received order and the order currently being processed.

According to the teaching herein, orders can be processed in parallel within a scope in which contract consistency is maintained.

The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF THE DRAWINGS

The present invention can be appreciated by the description which follows in conjunction with the following figures, wherein:

FIG. 1 is a diagram for illustrating an overall configuration of a system according to this embodiment;

FIG. 2 is a block diagram for illustrating a physical configuration of an order reception processing server according to this embodiment;

FIG. 3 is a diagram for illustrating an example of a structure of product specification information according to this embodiment;

FIG. 4 is a diagram for illustrating an example of a structure of product attribute information according to this embodiment;

FIG. 5 is a diagram for illustrating an example of a structure of product attribute relationship information according to this embodiment;

FIG. 6 is a diagram for illustrating an example of a structure of contract product information according to this embodiment;

FIG. 7 is a diagram for illustrating an example of a structure of currently-processing order management information according to this embodiment;

FIG. 8 is a flowchart of processing executed by an order reception processing module according to this embodiment;

FIG. 9 is a flowchart of processing executed by a preceding order check processing module according to this embodiment;

FIG. 10 is a flowchart of processing executed by an order completion processing module according to this embodiment;

FIG. 11 is a diagram for illustrating an example of a product design screen according to this embodiment; and

FIG. 12 is a diagram for illustrating an example of an association setting screen among product attributes according to this embodiment.

### DETAILED DESCRIPTION OF THE EMBODIMENTS

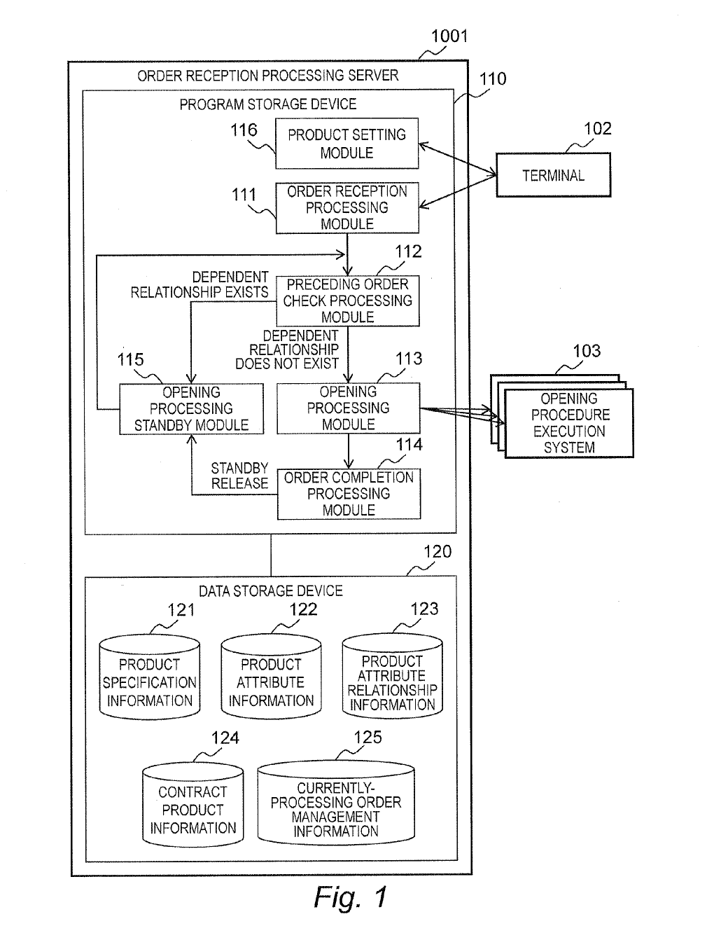

An embodiment according to this invention is now described with reference to FIG. 1 to FIG. 12. In this embodiment, order reception processing and a product design method performed when a communications service provider, such as a communications carrier, sells communications services as products for a mobile telephone and the like are described.

It should be noted that, in the figures used in the embodiment, parts denoted by the same reference symbols represent the same configurations or processing, and the configurations and operations thereof are basically the same.

### First Embodiment

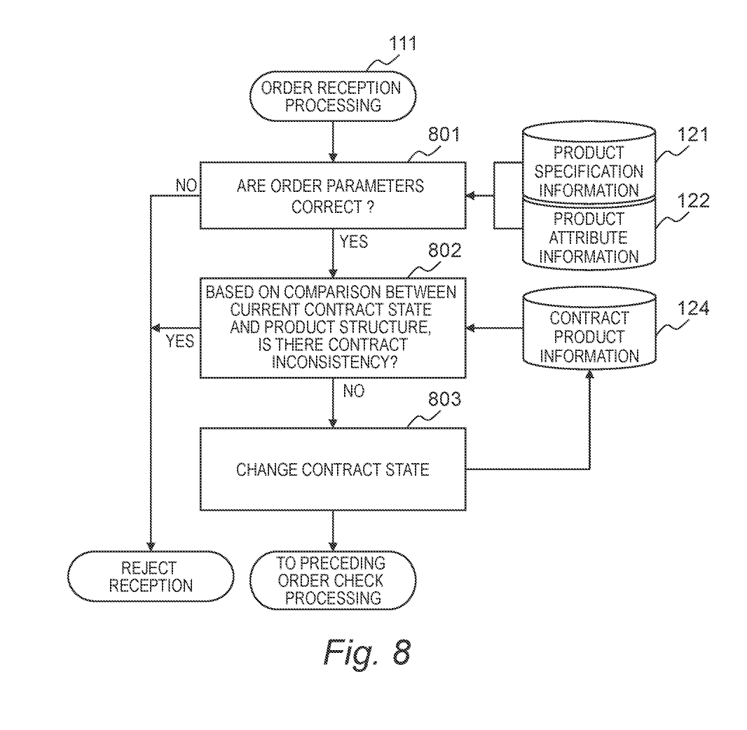

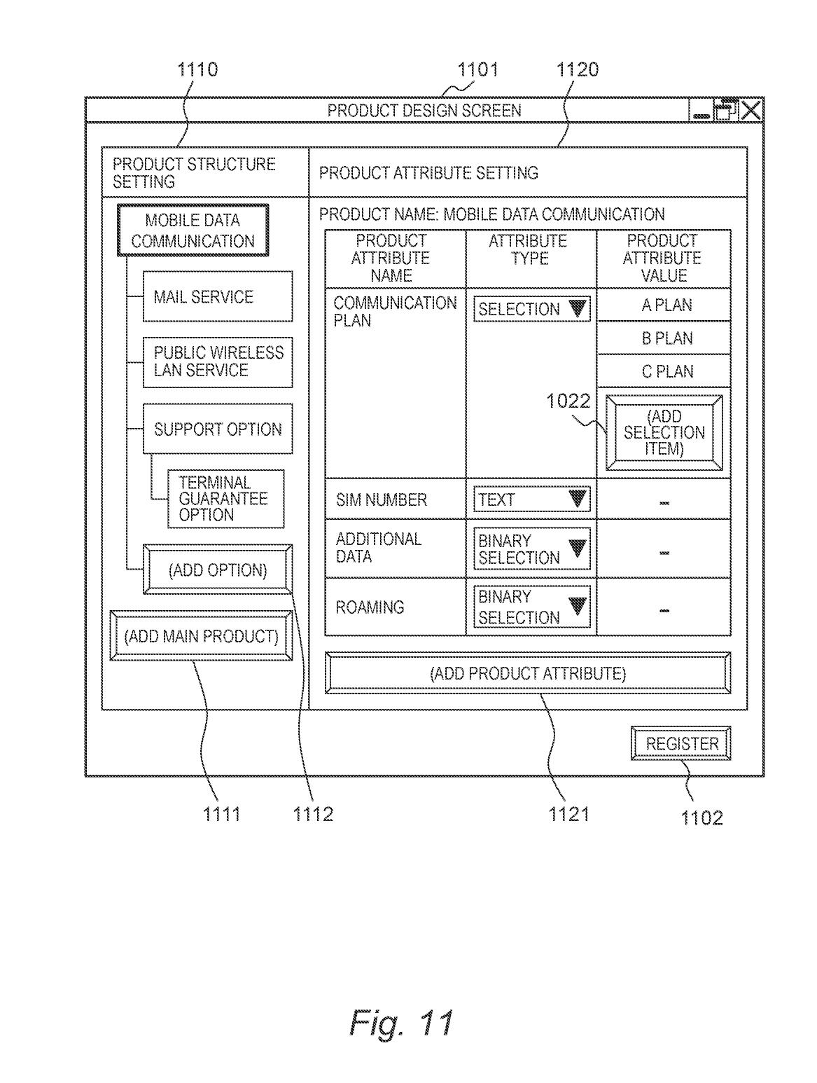

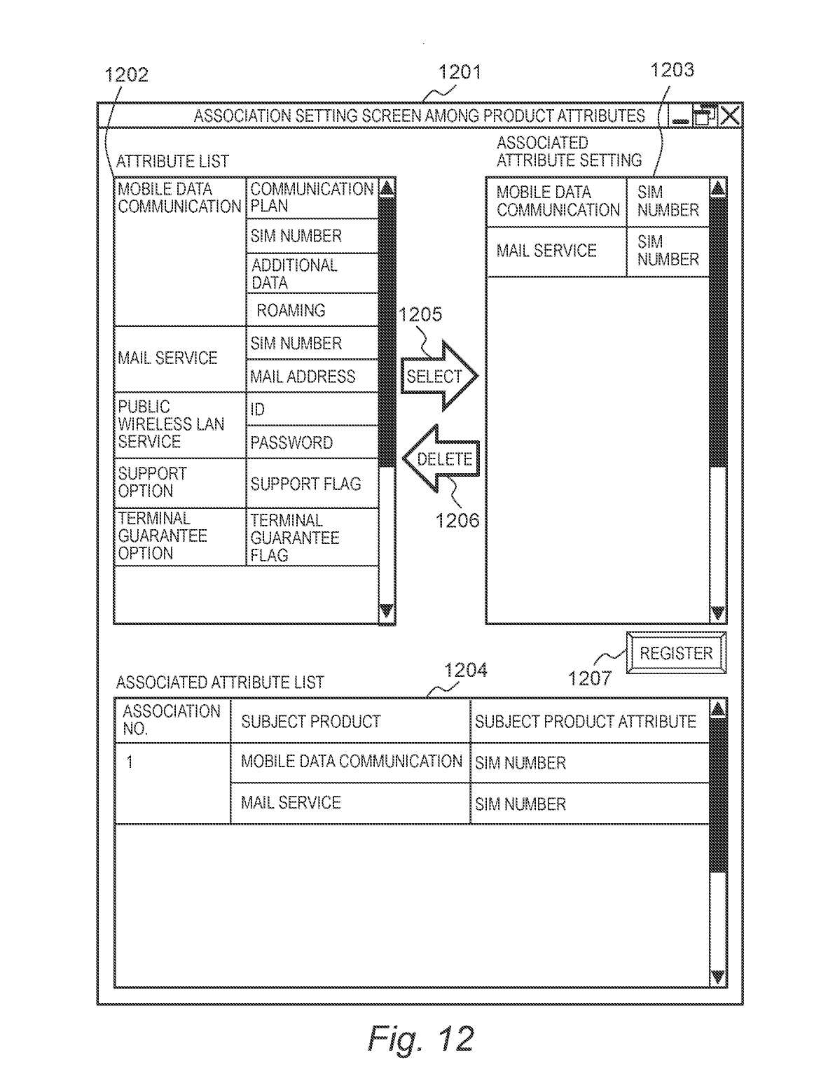

First, an overall system configuration according to this embodiment and an example of a structure of the information handled by the system are described with reference to FIG. 1 to FIG. 7. Following that, processing for receiving orders, executing a consistency check of the processing of a preceding order and a subsequent order, and executing processing of the orders in parallel within a scope in which contract consistency is maintained, is described with reference to FIG. 8 to FIG. 10. Lastly, an example of a screen for designing a product specification, product attributes, and a product attribute relationship is described with reference to FIG. 11 and FIG. 12.

FIG. 1 is a diagram for illustrating an overall configuration of a system according to this embodiment.

The system according to this embodiment includes an order reception processing server 101 managed by a communications service provider, and an opening procedure execution system 103 configured to perform settings in equipment for realizing a communications service. A terminal 102 configured to allow a service user or agent to upload orders to the communications service provider is coupled to the order reception processing server 101.

The opening procedure execution system 103 may be managed by the communications service provider, or may be managed by another provider. For example, in a case where the communications service provider is a Mobile Virtual Network Operator (MVNO) provider, the MVNO provider manages the order reception processing server 101, but a Mobile Network Operator (MNO) provider manages the opening procedure execution system 103.

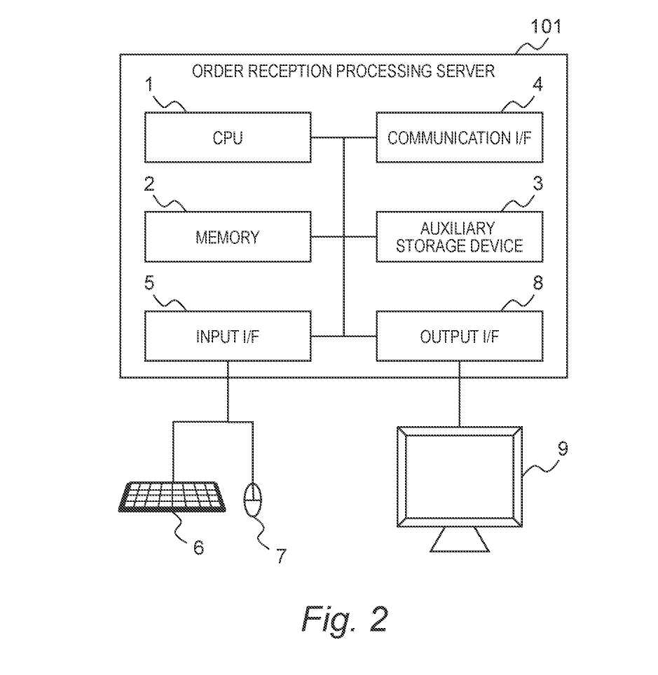

In a case where the order reception processing server 101 receives an order from the terminal 102, the order reception processing server 101 executes processing by combining operations of an order reception processing module 111, a preceding order check processing module 112, an opening processing module 113, an order completion processing module 114, and an opening processing standby module 115. Each of those modules is stored in a program storage device 110. Further, the order reception processing server 101 includes a product setting module 116 configured to set the product to be set by the order. The program storage device 110 is mainly constructed of a memory (random-access memory (RAM)) 2 (illustrated in FIG. 2). In the following, when “XXX module” is the subject of a sentence, a processor 1 reads a program from an auxiliary storage device 3, and loads and executes the program on the memory 2 to realize the function of the program.

The order reception processing module 111 is configured to receive an order from the terminal 102, compare a structure of the product to be provided with a current contract state, and determine whether or not the order can be received. The processing performed by the order reception processing module 111 is described in more detail later with reference to FIG. 8.

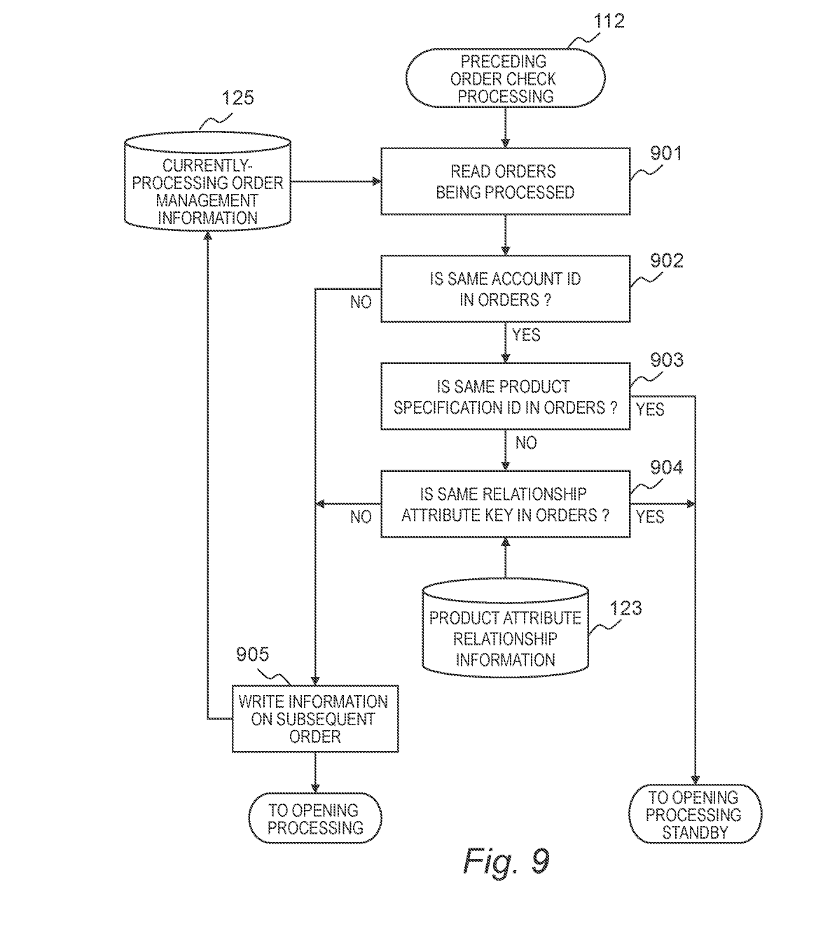

The preceding order check processing module 112 is configured to check a dependent relationship between a preceding order and an order determined by the order reception processing module 111 as being receivable. Further, the preceding order check processing module 112 is configured to determine whether or not the order can be executed in parallel, or whether execution of the order needs to wait until completion of the preceding order. The processing performed by the preceding order check processing module 112 is described in more detail later with reference to FIG. 9.

The opening processing module 113 is configured to set a parameter in the opening procedure execution system 103 based on the content of the order. Specifically, the opening processing module 113 is configured to transmit the parameter to be set to a network interface (I/F) of the opening procedure execution system 103.

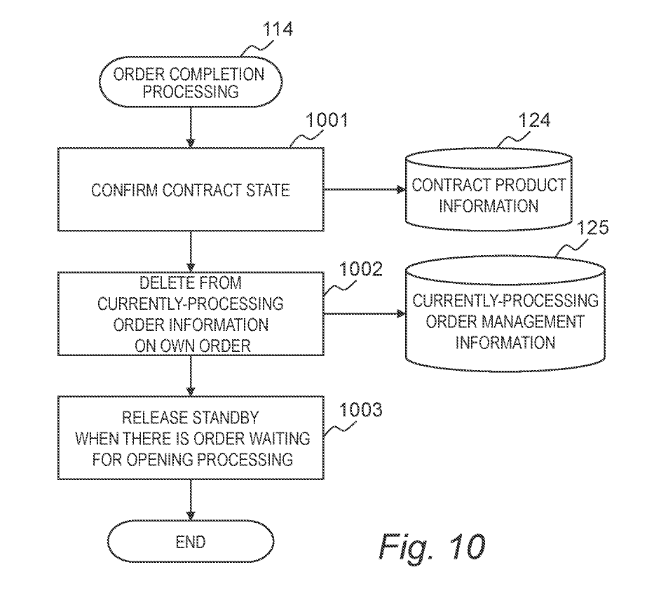

The order completion processing module 114 is configured to confirm the contract state of an order for which opening processing has been completed, and issue, for an order that is determined by the preceding order check processing module 112 as having a dependent relationship and that is waiting for completion of the preceding order, a standby release notification to the opening processing standby module 115. The processing performed by the order completion processing module 114 is described in more detail later with reference to FIG. 10.

The opening processing standby module 115 is configured to manage information on the order that is determined to wait for completion of the preceding order by the preceding order check processing module 112. In other words, the opening processing standby module 115 is configured to return, in a case where a standby release notification is received from the order completion processing module 114, the order on standby that is associated with the completed order to the preceding order check processing module 112, and restart processing.

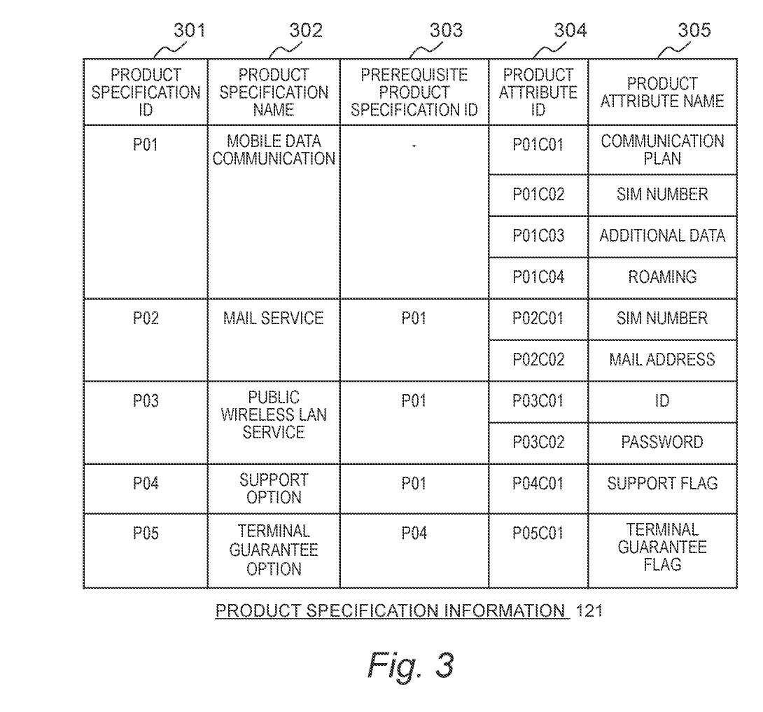

The order reception processing server 101 is configured to manage product specification information 121, product attribute information 122, product attribute relationship information 123, contract product information 124, and currently-processing order management information 125. Each of those pieces of information is stored in a data storage device 120. Each piece of information is referenced and updated by processing performed by the various modules in the program storage device 110. Details of those pieces of information are described later with reference to FIG. 3 to FIG. 7. The data storage device 120 is mainly constructed of the auxiliary storage device 3 (illustrated in FIG. 2).

The terminal 102 and the opening procedure execution system 103 can be executed by any known technology, and hence the details of the internal configurations thereof are not shown in FIG. 1.

The terminal 102 is a computer including a processor, a memory, a storage device, and a network interface. The functions of programs stored in the memory are realized by the processor executing those programs. For example, in the terminal 102, a browser is running. Screen data (web page) output from the order reception processing server 101 is displayed to the operator. Inputs by the operator are received by the terminal 102, and transmitted to the order reception processing server 101. It should be noted that a dedicated application program may be installed on the terminal 102, and the display screen may be generated by the terminal 102 by using information output from the order reception processing server 101.

The opening procedure execution system 103 is a computer including a processor, a memory, a storage device, and a network interface. The functions of programs stored in the memory are realized by the processor executing those programs.

FIG. 2 is a block diagram for illustrating a physical configuration of the order reception processing server 101 according to this embodiment.

The order reception processing server 101 according to this embodiment is constructed of a computer including a processor (central processing unit (CPU)) 1, a memory 2, an auxiliary storage device 3, and a communication interface 4.

The processor 1 is configured to execute programs stored in the memory 2. The memory 2 includes a ROM as a nonvolatile storage element, and a RAM as a volatile storage element. The ROM stores therein an invariable program (for example, a BIOS) or the like. The RAM is a high-speed volatile storage element such as a dynamic random access memory (DRAM) and is configured to temporarily store therein a program to be executed by the processor 1, and data to be used in executing the program.

The auxiliary storage device 3 is, for example, a large-scaled nonvolatile storage device such as a magnetic storage device (HDD) and a flash memory (SDD) and is configured to store therein a program to be executed by the processor 1 and data to be used in executing the program. In other words, the program is read out from the auxiliary storage device 3 to be loaded into the memory 2, and is executed by the processor 1.

The communication interface 4 is a network interface apparatus configured to control communication to/from another apparatus (terminal 102, opening procedure execution system 103) in accordance with a predetermined protocol.

The order reception processing server 101 may also include an input interface 5 and an output interface 8. The input interface 5, which is coupled to a keyboard 6, a mouse 7, and the like, is configured to receive inputs from the operator. The output interface 8, which is coupled to a display apparatus 9, a printer, and the like, is configured to output an execution result of a program in a form that can be seen by the operator.

A program to be executed by the processor 1 is provided for the order reception processing server 101 through a removable medium (such as a CD-ROM and a flash memory) or a network, and is then stored in the nonvolatile storage device 3 as a non-temporary storage medium. For this reason, it is preferred that the order reception processing server 101 have an interface through which data is read from the removable medium.

The order reception processing server 101 is a computer system which is physically configured on one computer or which is configured on a plurality of logical or physical computers. In addition, the computer system may be operated in separate threads on the same computer, or may be operated on a virtual computer constructed on a plurality of physical computer resources.

Next, structures of the information managed by the data storage device 120 in the order reception processing server 101 is described with reference to FIG. 3 to FIG. 7. In the following description, various types of information are described in a table format. However, the various types of information may be expressed in any kind of data structure, including a table, a list, a database (DB), a queue, and the like.

FIG. 3 is a diagram for illustrating an example of the structure of the product specification information 121.

The product specification information 121 is information on the specification of the product, such as the configuration or the settable items of the product to be provided by the communications service provider. The product specification information 121 includes a product specification identification (ID) 301 for uniquely identifying the product, a product specification name 302 representing the name of the product, a prerequisite product specification ID 303 indicating the product for which a contract should be concluded before concluding a contract for the product, a product attribute ID 304 for uniquely identifying settable items for the product, and a product attribute name 305 representing the name of a product attribute. Those pieces of information are associated with each other.

In the prerequisite product specification ID 303, “-” is set in a case where the product is the subject of the main contract, and hence the product does not require any prerequisite products. In a case where the specification of an optional product is to be defined, the product specification ID of the product that is the subject of the main contract is set in the prerequisite product specification ID 303.

Further, the attributes of the product specification set the items corresponding to the parameters to be set in the opening procedure execution system 103 in order to open the service. In other words, one product specification is defined for one opening procedure execution system 103, and the product attributes are defined corresponding to the parameters to be transmitted to the opening procedure execution system 103. Therefore, in a case where a plurality of services are provided by the opening procedure execution system 103, the plurality of services are defined as one product specification that bundles the services together. In addition, in a case where the service of an option is to be defined, the service is defined by switching a value in the product attribute. For example, if mobile data communication is defined as the product specification and an additional data option or a roaming option, which is an option for mobile data communication, is to be handled by the same opening procedure execution system 103, that option is defined as an attribute of the product specification of the mobile data communication.

Thus, as the design of an optional product, two methods are provided, one method in which, in a case where the opening procedure execution system 103 is the same, the optional product is defined as an attribute of the product specification to serve as the main contract, and another method in which, in a case where the opening procedure execution system 103 is different, the product specification to serve as the main contract is set in the prerequisite product specification ID 303, and defined as one independent product specification.

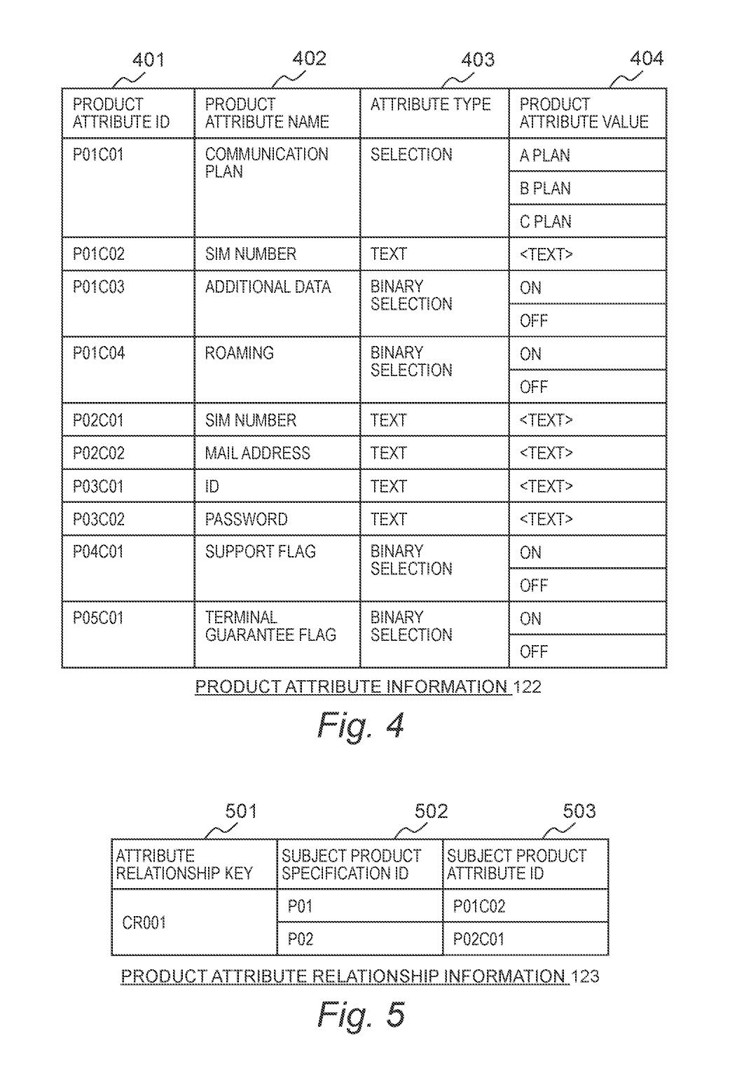

FIG. 4 is a diagram for illustrating an example of the structure of the product attribute information 122.

The product attribute information 122 is information for managing the values that the product attributes defined by the product specification information 121 can take. The product attribute information 122 includes a product attribute ID 401 for uniquely identifying the product attribute, a product attribute name 402 representing the name of the product attribute, an attribute type 403 representing the type of values that the product attribute value can take, and a product attribute value 404 that is settable based on the attribute type 403. Those pieces of information are associated with each other.

The product attribute ID 401 and the product attribute name 402 are respectively the same as the product attribute ID 304 and the product attribute name 305 in the product specification information 121 (FIG. 3). In the attribute type 403, “selection” is set in a case where setting a plurality of selection choices as the product attribute value 404, “text” is set in a case where setting an arbitrary value of a number, a character string, and the like, and “binary selection” is set in a case where setting either/or selection choices such as ON and OFF. In the product attribute value 404, a settable value is set based on the attribute type 403.

FIG. 5 is a diagram for illustrating an example of the structure of the product attribute relationship information 123.

The product attribute relationship information 123 is information for managing the fact that there is a relationship among the product attributes of a plurality of product specifications. The product attribute relationship information 123 includes an attribute relationship key 501 for uniquely identifying a setting of a relationship definition of the product attribute, a subject product specification ID 502 representing the product specification ID referred to in the attribute relationship key 501, and a subject product attribute ID 503 representing the attribute of the subject product specification. Those pieces of information are associated with each other.

For example, in the product attribute relationship information 123 shown in the FIG. 5, the product attribute name “SIM number”, which is set in common with mobile data communication having the product specification ID “P01” and a mail service having the product specification ID “P02”, is associated. Specifically, the SIM number is used for a parameter of the opening procedure execution system 103 of mobile data communication, and the SIM number is also used for a parameter of the opening procedure execution system 103 of the mail service.

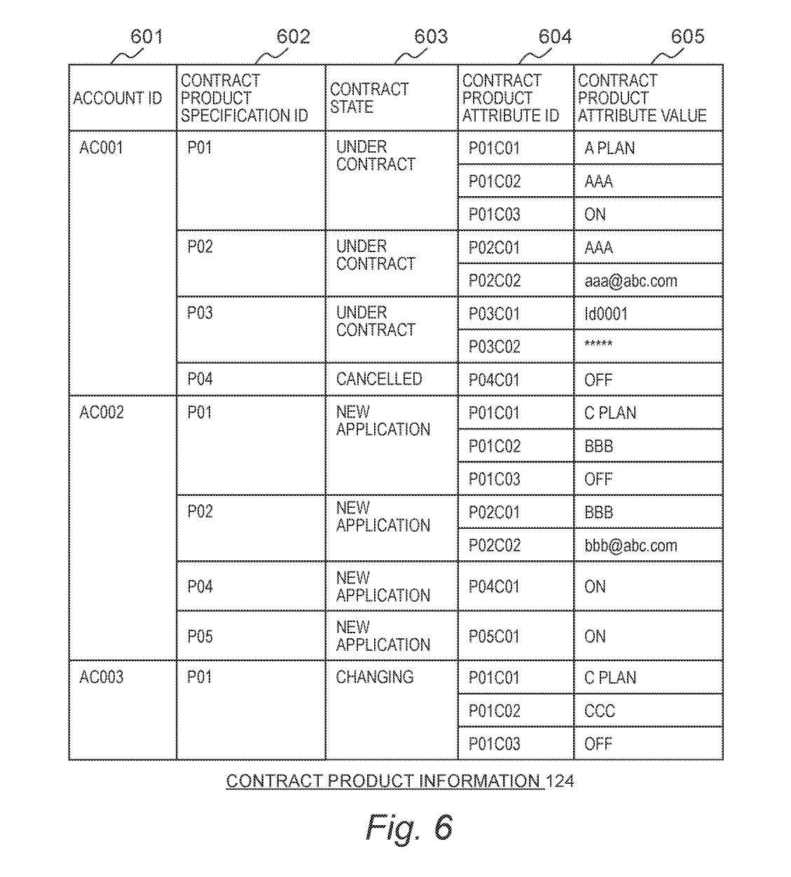

FIG. 6 is a diagram for illustrating an example of the structure of the contract product information 124.

The contract product information 124 is information for managing products that are currently under contract by the service user and products for which a change order has been received. The contract product information 124 includes an account ID 601 for uniquely identifying the service user, a contract product specification ID 602 representing a product that is under contract by the service user or a product for which a change procedure is being performed, a contract state 603 representing whether or not the product relating to the contract product specification ID 602 is a product under contract or a product for which a change procedure is being performed, a contract product attribute ID 604 representing the product attributes of the product relating to the contract product specification ID 602, and a contract product attribute value 605 for each contract product attribute ID 604 selected and set by the service user when concluding the contract. Those pieces of information are associated with each other.

For a state currently under contract, the contract state 603 is set to “under contract”. For a state in which a change procedure is being performed, the contract state 603 is set to any one of “new application” in a case where newly adding a product, “changing” in a case where changing only an attribute value of a product which has been under contract, and “cancelled” in a case where cancelling a product under contract.

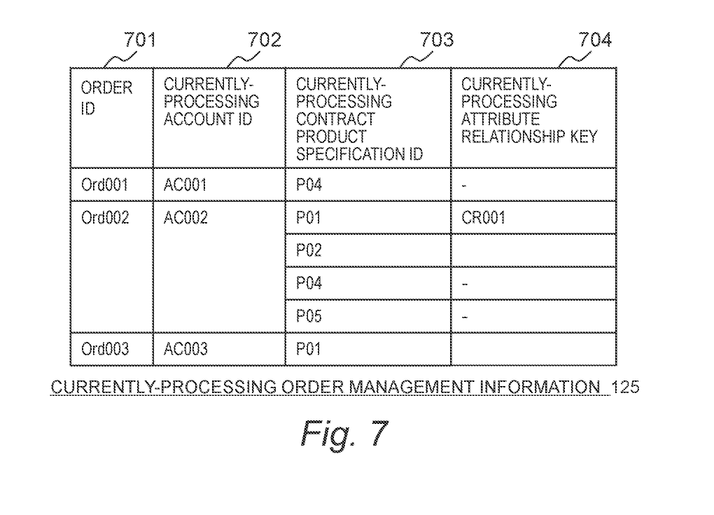

FIG. 7 is a diagram for illustrating an example of the structure of the currently-processing order management information 125.

The currently-processing order management information 125 is information for managing the orders that the order reception processing server 101 is currently processing. The currently-processing order management information 125 includes an order ID 701 for uniquely identifying the orders currently being processed, a currently-processing account ID 702 for uniquely identifying the service user relating to the orders currently being processed, a currently-processing product specification ID 703 representing the products that are being processed by the orders currently being processed, and a currently-processing attribute relationship key 704 representing a relationship of the attributes of the products that are being processed by the orders currently being processed. Those pieces of information are associated with each other. In a case where the product attributes of the products that are being processed by the orders currently being processed are the same as the subject product attribute ID 503 in the product attribute relationship information 123, the attribute relationship key 501 associated with the subject product attribute ID 503 is set for the currently-processing attribute relationship key 704.

Information on the preceding order is stored in the currently-processing order management information 125. In a case where processing a subsequent order, a dependent relationship between the preceding order and the subsequent order is determined by referring to the currently-processing order management information 125. The method of determining the dependent relationship is described based on a flowchart of the preceding order check processing module 112 (FIG. 9).

The overall configuration of the system according to this embodiment and the structure of the information handled by the system have been described above. Based on this system configuration and information structure, a sequence for receiving orders by the order reception processing server 101, performing a consistency check of the processing of a preceding order and a subsequent order, and processing the orders in parallel within a scope in which consistency is maintained, is described with reference to FIG. 8 to FIG. 10.

FIG. 8 is a flowchart of processing executed by the order reception processing module 111 in the order reception processing server 101.

In this processing, the order reception processing module 111 receives an order uploaded by the terminal 102, checks the consistency of the contract state, and determines whether or not the order can be received.

First, the order reception processing module 111 checks whether or not the parameters included in the received order are correctly set (Step 801). For example, using the product specification information 121 and the product attribute information 122, the order reception processing module 111 checks whether or not all of the attribute values required in the product specification are set, and whether or not there are any errors in the attribute values.

Next, the order reception processing module 111 compares the parameters (product structure) of an order that has completed being checked and the contract product information 124 (current contract state), and checks whether or not there is an inconsistency in the contract in terms of the product structure (Step 802). For example, while the product that is the subject of the main contract is cancelled, the order reception processing module 111 rejects reception of orders adding an optional product of the product that is the subject of the main contract, and rejects reception of orders changing an attribute value of the product that is the subject of the main contract.

In a case where there are no inconsistencies in the contract, the order reception processing module 111 changes the contract state (Step 803). Specifically, in the case of adding a product, the order reception processing module 111 changes an attribute of the product by adding a record in which the contract state 603 of the contract product information 124 is set to “new application”. Further, in the case of cancelling a product, for a product having “under contract” as the contract state 603 in the contract product information 124, the order reception processing module 111 changes the contract state 603 to “changing” or “cancelled”.

Based on the processing described above, only an order capable of ensuring the consistency of the contract in terms of product structure can be received.

Next, a determination is made regarding whether or not parallel processing can be executed by checking the consistency of a subsequent order for which reception has been allowed by the order reception processing module 111 in FIG. 8 in terms of the opening procedure with a preceding order currently being processed (FIG. 9).

FIG. 9 is a flowchart of processing executed by the preceding order check processing module 112 in the order reception processing server 101.

First, the preceding order check processing module 112 reads from the currently-processing order management information 125 all of the information on the orders currently being processed (Step 901).

Next, the preceding order check processing module 112 checks whether or not an account ID that is the same as that of the subsequent order is in the read information on the orders being processed (Step 902). In a case where the same account ID is not in the order information, this means that there is no preceding order with a dependent relationship. Therefore, the preceding order check processing module 112 writes the information on the subsequent order in the currently-processing order management information 125 (Step 905), and transfers the subsequent order to the opening processing module 113. On the other hand, in a case where the same account ID is included in the order information, the preceding order check processing module 112 checks whether or not the same product specification ID is in the order information (Step 903).

In a case where the same product specification ID is in the order information, this means that there is a preceding order having a dependent relationship with the subsequent order, and hence the preceding order check processing module 112 transfers the subsequent order to the opening processing standby module 115. On the other hand, in a case where the same product specification ID is not in the order information, the preceding order check processing module 112 reads the attribute relationship key 501 associated with the product attribute that is the subject of the subsequent order from the product attribute relationship information 123, and checks whether or not there is the same attribute relationship key 501 in the same account of the currently-processing order management information 125 (Step 904).

In a case where the same attribute relationship key 501 is in the same account, this means that there is a preceding order having a dependent relationship with the subsequent order, and hence the preceding order check processing module 112 transfers the subsequent order to the opening processing standby module 115. On the other hand, in a case where the same attribute relationship key 501 is not in the same account, the preceding order check processing module 112 writes the information on the subsequent order in the currently-processing order management information 125 (Step 905), and transfers the subsequent order to the opening processing module 113.

Based on the processing described above, a dependent relationship relating to the opening procedure of a product can be checked by utilizing the product specification defined by the product design and an attribute relationship among the product specifications. Further, even for a change order of a product for the same account, the opening procedure can be processed in parallel as long as there is no dependent relationship with a preceding order.

Lastly, the processing performed by the opening processing module 113 is completed to compete the order (FIG. 10).

FIG. 10 is a flowchart of processing executed by the order completion processing module 114 in the order reception processing server 101.

First, in a case where the order processing finishes, the order completion processing module 114 confirms the contract by changing the contract state 603 in the contract product information 124 to “under contract” (Step 1001). In a case where the order is an order relating to cancellation, the contract state 603 is set to “cancelled”, or the relevant record in the contract product information 124 is deleted.

Next, the order completion processing module 114 deletes the information on the order to be completed from the currently-processing order management information 125 (Step 1002). Lastly, the order completion processing module 114 releases from standby an order that is waiting for opening processing (Step 1003), and finishes the processing.

Based on the processing flow illustrated in FIG. 8 to FIG. 10, an order not having a dependent relationship in terms of opening procedure can be processed in parallel while maintaining contract consistency, by checking, after the order has been received, the contract consistency and the dependent relationship with preceding orders in terms of the opening procedure.

In order to realize those processing flows, the product specification information 121, the product attribute information 122, and the product attribute relationship information 123 need to be set in advance at the design stage of the product. Hitherto, product design has defined only the structure of the product relating to the contract, such as for the product that is the subject of the main contract and products that are options to the main contract. However, in this embodiment, in addition to the structure of the product relating to the contract, the product attribute information 122 and the product attribute relationship information 123 need to be set. Therefore, a method of designing the product specification information 121, the product attribute information 122, and the product attribute relationship information 123 is now described with reference to FIG. 11 and FIG. 12.

A product design screen 1101 (FIG. 11) and an association setting screen 1201 among product attributes (FIG. 12) are configured to be output by the product setting module 116 and to receive inputs from the terminal 102.

FIG. 11 is a diagram for illustrating an example of the product design screen 1101 for designing the product specification information 121 and the product attribute information 122.

The product design screen 1101 includes a product structure setting field 1110 configured to define a relationship between the product that is the subject of the main contract and products that are options to the product that is the subject of the main contract, and a product attribute setting field 1120 configured to set a product attribute name, a product attribute type, and a product attribute value, which form the product specification of each product.

In the product structure setting field 1110, the product that is the subject of the main contract can be added by pressing an add main product button 1111. Further, products that are options to the product that is the subject of the main contract can be set by pressing an add option button 1112.

In the product attribute setting field 1120, the product specification of each product set in the product structure setting field 1110 is set. One product is selected from the product structure setting field 1110 to display a list of the product specifications that are set, and the product attribute name is added by using an add product attribute button 1121. Then, an attribute value for each product attribute name is set. In a case where the attribute type for the product attribute name is “select”, a product attribute value is added by pressing an add selection item button 1122.

After all of the items in the product structure setting field 1110 and the product attribute setting field 1120 are set, a product specification ID of the newly added product specification is created and stored in the product specification information 121 by pressing a register button 1102. Further, a product attribute ID of the newly added product attribute is created and stored in the product specification information 121 and the product attribute information 122.

It should be noted that in a case where deleting information on an added product or an added product specification, the information may be deleted by using a pull-down menu that is displayed by selecting the item to be deleted and right-clicking on a mouse, which is a common computer input device. Further, the information may also be deleted by using a pull-down menu displayed by overriding a mouse cursor.

FIG. 12 is a diagram for illustrating an example of the association setting screen 1201 among product attributes for setting relationships among the product attributes of the product specifications set in FIG. 11.

The association setting screen 1201 among product attributes includes an attribute list field 1202 configured to display a list of the products and the attributes of the product specification set on the product design screen 1101, an associated attribute setting field 1203 configured to set an association among a plurality of product attributes selected from the attribute list field 1202, and an associated attribute list field 1204 configured to display a list of confirmed attribute relationships.

First, the operator selects a product attribute utilizing the same parameter from the attribute list field 1202, and proceeds to the associated attribute setting field 1203 by pressing a select button 1205. After all of the associated product attributes have been selected, the operator presses a register button 1207. By performing this operation, the product attributes are associated with each other, and an associated attribute key is created. The associated attribute key is stored in a table in the product attribute relationship information 123, and displayed in the associated attribute list field 1204.

Further, in a case where the operator has proceeded to the associated attribute setting field 1203 by making a mistaken selection, the operator can release his/her selection by using a delete button 1206.

In addition, even when the association among the product attributes has been confirmed by pressing the register button 1207, a mistaken selection can be deleted by selecting the association number of the associated attribute list field 1204 to display the setting information in the associated attribute setting field 1103.

With the above-mentioned product design screen 1101 and association setting screen 1201 among product attributes, the information on the product specification information 121, the product attribute information 122, and the product attribute relationship information 123, which need to be set as the product design, can be easily set in a manner that is visually easy to understand. As a result, the work involved in designing the product specification information 121, the product attribute information 122, and the product attribute relationship information 123 can be reduced. Further, by utilizing the product specification information 121, the product attribute information 122, and the product attribute relationship information 123, the processing for checking the dependent relationship between a preceding order and a subsequent order in terms of the opening procedure can be automated. Further, because the items to be checked during reception are determined in a case of designing a product, during development of order reception processing, there is no need to register all combinations of the products, and hence the number of development steps in the dependent relationship check processing can be decreased.

As described above, in this embodiment, even when there is a preceding order being processed made by the contracting party of a received subsequent order, and the subsequent order and the preceding order are for different products, as long as a currently-processing attribute relationship key of the subsequent order is not registered in the currently-processing order management information, namely, as long as there is not a dependent relationship between the preceding order and the subsequent order, even before processing of the preceding order is complete, a determination is made to start processing without controlling the subsequent order to wait. In other words, contract consistency based on consecutive orders is determined by using the contract state of the products and a dependent relationship in the opening procedure of the products defined at the product design stage, which enables the scope in which contract consistency is maintained to be reliably determined. Further, in a case where contract consistency is maintained, the preceding order and the subsequent order are processed in parallel without controlling the subsequent order to wait. As a result, orders can be processed in parallel within the scope in which contract consistency is maintained.

Further, the order reception processing server 101 is configured to determine that, in a case where there is a preceding order being processed made by the contracting party of a subsequent order, and the subsequent order and the preceding order by that contracting party are for the same product, the processing of the subsequent order is controlled to wait. In addition, the order reception processing server 101 is configured to determine that, in a case where there is a preceding order being processed made by the contracting party of a subsequent order, the subsequent order and the preceding order by that contracting party are for different products, and, the currently-processing attribute relationship key of the subsequent order is registered in the currently-processing order management information, there is a dependent relationship between the attributes of the product in the subsequent order and the attributes of the product in the preceding order, and hence processing of the received order is controlled to wait. As a result, the scope in which consistency is maintained can be reliably determined.

Still further, in this embodiment, among the products in the order, products received in different opening procedure execution systems 103 are registered in the product specification information 121 as different products. Therefore, checking whether or not a preceding order being processed and the subsequent order include the same product specification ID enables a determination to be made regarding whether or not to transmit a parameter to be set in the same opening procedure execution system 103.

In addition, because the order completion processing module 114 deletes orders for which processing has been completed from the currently-processing order management information 125, order standby can be reliably released, the waiting time of orders on standby can be reduced, and processing can be performed rapidly.

Although the present disclosure has been described with reference to exemplary embodiments, those skilled in the art will recognize that various changes and modifications may be made in form and detail without departing from the spirit and scope of the claimed subject matter.

The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, processing modules, and processing means, for all or a part of them, may be implemented by hardware: for example, by designing an integrated circuit, and may be implemented by software, which means that a processor interprets and executes programs providing the functions.

The information of programs, tables, and files to implement the functions may be stored in a storage device such as a memory, a hard disk drive, or an SSD (a Solid State Drive), or a storage medium such as an IC card, or an SD card.

The drawings illustrate control lines and information lines as considered necessary for explanation but do not illustrate all control lines or information lines in the products. It can be considered that almost of all components are actually interconnected.

What is claimed is:

1. An order processing system configured with a computer, comprising:
a processor; and
a storage device capable of storing instructions executable by the processor,
the storage device being configured to store specification information representing a relationship among products to be provided by a service provider, attribute information representing attributes of the products, attribute relationship information representing a dependent relationship of the attributes among the products, contract information representing a product under contract by a user and a product for which a procedure is being performed, and currently-processing order management information for managing orders currently being processed,
the instructions causing the processor to execute:
a reception processing part configured to check the consistency of an order received from a terminal and receive the order maintaining consistency by referring to the specification information, the attribute information, and the contract information; and
a preceding order check processing part configured to determine whether or not there is a dependent relationship between the attributes of the product in the received order and the attributes of the products included in the orders currently being processed by referring to the currently-processing order management information and the attribute relationship information,
the preceding order check processing part being configured to:
register the dependent relationship in the currently-processing order management information in a case where the received order and an order currently being processed, which are made by the same contracting party, have a dependent relationship in terms of an attribute of a subject product; and
determine to perform processing without controlling the received order to wait even before processing of the order currently being processed is complete in a case where there is an order currently being processed, which is made by the same contracting party of the received order, and there is no dependent relationship between the received order and the order currently being processed.

2. The order processing system according to claim 1, wherein the preceding order check processing part is configured to:
determine whether or not there is an order currently being processed made by the contracting party of the received order by referring to the currently-processing order management information;
determine whether or not a product in the received order and a product in an order currently being processed, which is made by the contracting party of the received order, are the same by referring to the currently-processing order management information;
determine whether or not there is a dependent relationship between attributes of the product in the received order and attributes of the product in the order currently being processed by referring to the currently-processing order management information and the attribute relationship information;
determine that processing of the received order is controlled to wait in a case where there is an order currently being processed, which is made by the contracting party of the received order, and the received order and the order currently being processed, which are made by the contracting party, are for the same product; and
determine that processing of the received order is controlled to wait in a case where there is an order currently being processed, which is made by the contracting party of the received order, the received order and the order currently being processed, which are made by the contracting party, are for different products, and, there is a dependent relationship between the attributes of the product in the received order and the attributes of the product in the order currently being processed.

3. The order processing system according to claim 2,
wherein the system is coupled to an external system configured to process the order, and
wherein products included in the order, which is received by the external systems, are registered as different products in the specification information.

4. The order processing system according to claim 1, the instructions further program the processor to execute an order completion processing part configured to delete an order for which processing is complete from the currently-processing order management information.

5. The order processing system according to claim 1, the instructions further program the processor to execute a product setting part configured to output data for displaying a product design screen including a structure setting region for setting a relationship among the products and an attribute setting region for setting an attribute representing a specification of the products, and register data input on the product design screen in the specification information and the attribute information.

6. The order processing system according to claim 5, wherein the product setting part is configured to:
output data for displaying an association setting screen for setting a dependent relationship of the attributes among the set products; and
register data input on the association setting screen in the specification information, the attribute information, and the attribute relationship information.

7. An order processing method, which is to be executed by a computer,
the computer including a processor and a storage device capable of storing instructions executable by the processor,
the storage device being configured to store specification information representing a relationship among products to be provided by a service provider, attribute information representing attributes of the products, attribute relationship information representing a dependent relationship of the attributes among the products, contract information representing a product under contract by a user and a product for which a procedure is being performed, and currently-processing order management information for managing orders currently being processed,
the order processing method comprising:
a reception processing step in which the processor receives an order maintaining consistency by referring to the specification information, the attribute information, and the contract information, and checking the consistency of an order received from a terminal; and
a preceding order check processing step in which the processor determines whether or not there is a dependent relationship between the attributes of the product in the received order and the attributes of the products in the orders currently being processed by referring to the currently-processing order management information and the attribute relationship information,
the preceding order check processing step including:
registering the dependent relationship in the currently-processing order management information in a case where the received order and an order currently being processed, which are made by the same contracting party, have a dependent relationship in terms of an attribute of a subject product; and
determining to perform processing without controlling the received order to wait even before processing of the order currently being processed is complete in a case where there is an order currently being processed, which are made by the contracting party of the received order, and there is no dependent relationship between the received order and the order currently being processed.

8. The order processing method according to claim 7,
wherein the preceding order check processing step includes:
determining whether or not there is an order currently being processed made by the contracting party of the received order by referring to the currently-processing order management information;
determining whether or not a product in the received order and a product in an order currently being processed, which is made by the contracting party of the received order, are the same by referring to the currently-processing order management information;
determining whether or not there is a dependent relationship between attributes of the product in the received order and attributes of the product in the order currently being processed by referring to the currently-processing order management information and the attribute relationship information;
determining that processing of the received order is controlled to wait in a case where there is an order currently being processed, which is made by the contracting party of the received order, and the received order and the order currently being processed, which are made by the contracting party, are for the same product; and
determining that processing of the received order is controlled to wait in a case where there is an order currently being processed, which is made by the contracting party of the received order, the received order and the order currently being processed, which are made by the contracting party, are for different products, and, there is a dependent relationship between the attributes of the product in the received order and the attributes of the product in the order currently being processed.

9. The order processing method according to claim 8,
wherein the computer is coupled to an external system configured to process the order, and
wherein products included in the order, which is received by the external systems, are registered as different products in the specification information.

10. The order processing method according to claim 7, further comprising an order completion processing step in which the processor deletes an order for which processing is complete from the currently-processing order management information.

11. The order processing method according to claim 7, further comprising a product setting step in which the processor outputs data for displaying a product design screen including a structure setting region for setting a relationship among the products and an attribute setting region for setting an attribute representing a specification of the products, and registering data input on the product design screen in the specification information and the attribute information.

12. The order processing method according to claim 11, wherein the product setting step includes:
outputting data for displaying an association setting screen for setting a dependent relationship of the attributes among the set products; and
registering data input on the association setting screen in the specification information, the attribute information, and the attribute relationship information.
